(19) United States
(12) Patent Application Publication
(10) Pub. No.: US 2006/0044807 A1
(43) Pub. Date: Mar. 2, 2006

(54) Reflector lamp

(76) Inventors: Oliver Bohme, Aachen (DE); Herbert Kreus, Stolberg (DE)

Correspondence Address: PHILIPS INTELLECTUAL PROPERTY & STANDARDS, P.O. BOX 3001, BRIARCLIFF MANOR, NY, 10510, US

(21) Appl. No.: 10/533,721

(22) PCT Filed: Oct. 30, 2003
(86) PCT No.: PCT/IB03/04841

§ 371 Date: May 3, 2005

(30) Foreign Application Priority Data
Nov. 8, 2002 (DE) 102 51 960.9

(51) Int. Cl. F21V 7/00

(52) U.S. Cl. 362/341

(57) ABSTRACT

The invention relates to a reflector lamp (1) with a reflector (2), with a lamp base (3), with a halogen burner (4), and with a cap (6) which envelops the halogen burner (4) at least partly and is retained by a bracket (7) which extends as a bridge from one reflector side to the other. According to the invention, the halogen burner (4) is surrounded by a glass bulb (5).

The invention relates to a reflector lamp with a reflector, with a lamp base, with a halogen burner, and with a cap which envelops the halogen burner at least partly and is retained by a bracket which extends as a bridge from one side of the reflector to the other.

Such a reflector lamp is known from U.S. Pat. No. 4,623,815. The lamp comprises a halogen burner in the form of a halogen incandescent lamp which is arranged on a lamp base and whose lamp bulb is enveloped by a cap.

If such a reflector lamp is inexpertly introduced into a holder, the halogen burner may be damaged such that lamp life is shortened.

The invention has for its object to improve a lamp such that damage during insertion is prevented.

This object is achieved by the characterizing feature of claim 1. According to the invention, the halogen burner is enveloped by a glass bulb. The halogen burner is arranged in the interior of said bulb and is thus protected. A direct access to the halogen burner is prevented thereby. Contacts and electrically conducting connection wires are not destroyed during insertion.

Advantageously, the glass bulb has a reflection layer. Light rays are reflected back to the reflector thereby, and an axial light radiation is enhanced. This improves a light emission characteristic and counteracts stray light.

In a simple manner, the glass bulb has a layer that is impermeable to light. Glare is prevented thereby.

Advantageously, the bottom of the glass bulb has an opening. Heat can escape from the bulb in this manner.

Advantageously, the lamp base has a cylindrical opening with a step into which the glass bulb can be inserted. The glass bulb is thus given a defined position both in radial and in axial direction.

Advantageously, the lamp base has a spring. The spring presses the glass bulb against an inner cylinder surface of the lamp base, so that the glass bulb is retained in particular in a second axial direction.

Advantageously, the glass bulb comprises a bulge. The reflector has an opening bounded by a reflector edge in its top portion. If this edge projects over or into the opening of the lamp base, and thus over the bulge of the glass bulb, the reflector will serve as a retaining means which defines the position of the bulb in the second axial direction.

Advantageously, the glass bulb and the cap are at a distance from one another. Heat may thus escape from the bulb and the cap, and a heat accumulation is avoided. A temperature balance of the lamp is improved thereby.

Advantageously, a spring is arranged between the glass bulb and the cap. The spring presses the glass bulb onto the step of the opening. The glass bulb is thus given a defined position in the second axial direction, and a secure seat is safeguarded for the bulb.

Advantageously, the glass bulb is at least partly surrounded by the cap. The glass bulb is given a defined position in the second axial direction thereby, and a secure retention of the glass bulb is safeguarded.

Advantageously, the halogen burner, also denoted two-pinch burner below, has two mutually opposed pinches. The two-punch burner has an ellipsoidal glass bulb with an optimized light emission characteristic.

Advantageously, the electrical return lead comprises a locking means. The glass bulb is retained in the second axial direction thereby, and a reliable retention of the glass bulb is safeguarded.

Advantageously, a bulb of the halogen burner has an IR coating. The coating reflects infrared radiation back onto the coil and thus improves an energy balance of the halogen burner.

Embodiments will now be explained in more detail below with reference to the drawing for a better understanding of the invention. In the drawing:

FIG. 1 is a diagrammatic picture of a reflector lamp,

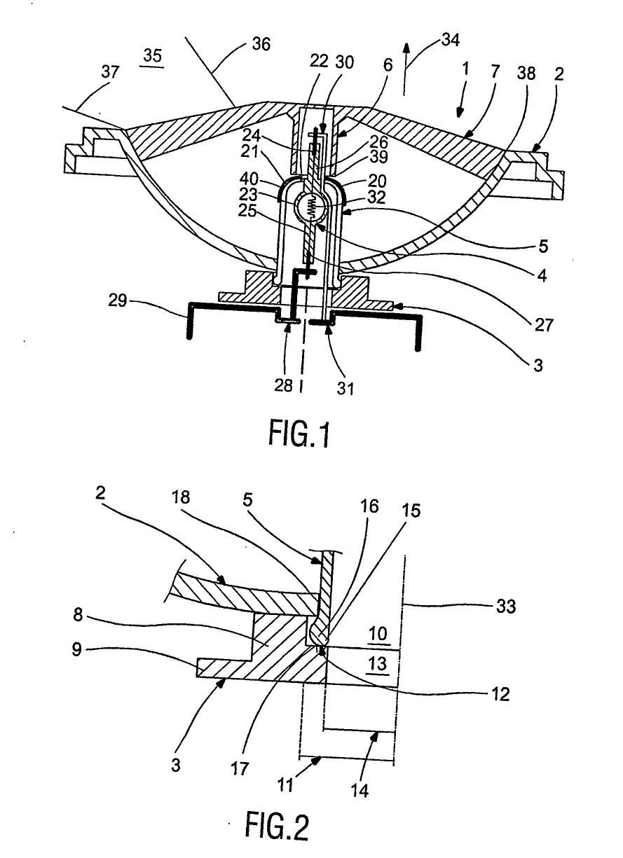

FIG. 2 shows a glass bulb held in a lamp base by a reflector edge in lateral sectional view,

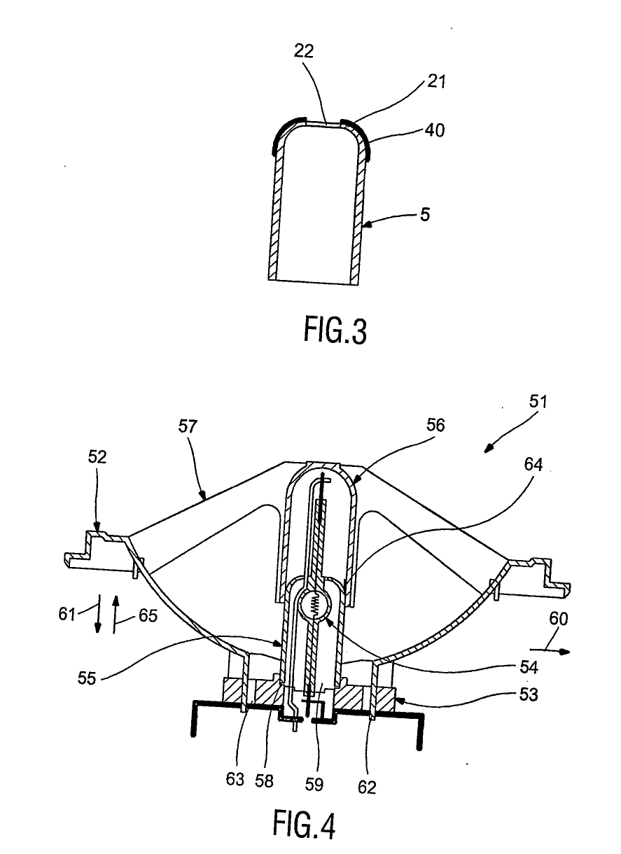

FIG. 3 shows a glass bulb in lateral sectional view, and

FIG. 4 shows a second reflector lamp in lateral sectional view.

FIGS. 1 and 2 show a reflector lamp 1 with a reflector 2, a ceramic lamp base 3, a halogen burner 4, a glass bulb 5, and a cap 6 which envelops the halogen burner 4 at least partly and is retained by a bracket 7 which extends in the form of a bridge from one side of the reflector to the other. The cap 6 and the bracket 7 are constructed as an integral component. The reflector 2 is held by the lamp base 3. The lamp base 3 has a tubular basic body 8 with a disc-shaped extension 9. Inside the tubular basic body 8, a first cylindrical opening 10 with a larger diameter 11 extends up to a step 12 and a second cylindrical opening 13 of smaller diameter 4. The glass bulb 5 has a cullet 16 at a first end 15. The glass bulb 5 is inserted with its cullet 16 into the opening 10 with radial clearance such that an end face 17 of the glass bulb 5 abuts the step 12. The reflector 2 extends with an inner reflector edge 15 over the cullet 16 of the glass bulb 15 so that the glass bulb 15 is held in the opening 10 of the lamp base 3. The bulb 5 has a bottom 21 with an opening 22 at its second end 20. The halogen burner 4 has an ellipsoidal glass body 23 with two mutually opposed pinched ends 24 and 25 which are traversed by respective electrical conductors 26 and 27. The end 24 projects through the opening 22 of the bottom 21 and into the cap 6. The glass body 23 is positioned in a focus of the reflector 2. The electrically conductive connection 27 extends inside the glass bulb 5 to an electrical contact 28 of which one part 29 is arranged below the lamp base 3. The electrically conductive connection 26 extends to an electrical return lead 30 which lies along the glass body 23 and leads to an electrical contact 31. The electrically conductive connections 26 and 27 lead to a coil 32 in the interior of the halogen burner 4. The ellipsoidal glass body 23, the coil 32, the cap 5, and the glass bulb 5 share a common longitudinal axis 33.

To obtain a good illumination, the lamp 1 should radiate light substantially within a defined angular region between the axial direction 34 and an azimuth angle 36. The lamp 1, however, also radiates light into a lateral region 35. This lateral region 35 illuminates a space which is defined by the azimuth angle 36 and a further azimuth angle 37. The azimuth angles 36 and 37 are defined by an outer reflector edge 38 and a cap edge 39. To deflect this light, which is denoted stray light, and to utilize it within a region between the axial direction 34 and the azimuth angle 36, the bottom 21 of the glass bulb 5 has a reflection layer 40. The reflection layer 40 reflects light onto the reflector 2, whereby the stray light in the region between the axial direction 34 and the azimuth angle 36 is deflected.

FIG. 3 shows the glass bulb 5 with the bottom 21, the opening 22, and the reflection layer 40 whose dimension is given by the azimuth angles 36 and 37. The reflection coating 40 reflects stray light back onto the reflector 2. Alternatively, the coating 40 may be formed as a layer impermeable to light.

FIG. 4 shows a reflector lamp 51 with a reflector 52, a ceramic lamp base 53, a halogen burner 54, a glass bulb 55, and a cap 56 which surrounds the halogen burner 54 at least partly and is retained by a bracket 57 which extends as a bridge from one side of the reflector to the other. The cap 56 and the bracket 57 are constructed as one integral component. The glass bulb 55 is inserted with an open end 58 into an opening 59 of the lamp base 53 such that its position is defined both in a radial direction 60 and in a first axial direction 61. The reflector 52 is retained by the lamp base 53. For this purpose, the reflector 52 has three projections 62 which extend into openings 63 of the lamp base 53 and are fastened therein by clamping, locking, or bending. The cap 56 envelops the glass bulb 55 and defines its position also in the radial direction 60. The cap 56 has an inwardly directed bulge 64 which retains the bulb 55 in a second axial direction 65.

1. A reflector lamp (1, 51) with a reflector (2, 52), with a lamp base (3, 53), with a halogen burner (4, 45), and with a cap (6, 56) which envelops the halogen burner (4, 54) at least partly and is retained by a bracket (7, 57) which extends as a bridge from one side of the reflector to the other, characterized in that the halogen burner (4, 54) is enveloped by a glass bulb (5, 55).

2. A reflector lamp as claimed in claim 1, characterized in that the glass bulb (5, 55) has a reflection layer (40).

3. A reflector lamp as claimed in claim 1, characterized in that the glass bulb (5, 55) has a layer (40) which is impermeable to light.

4. A reflector lamp as claimed in one or several of the preceding claims 1 to 3, characterized in that a bottom (21) of the glass bulb (5, 55) has an opening (22).

5. A reflector lamp as claimed in claim 1, characterized in that the lamp base (3, 53) has a cylindrical opening (10, 13, 59) with a step (12).

6. A reflector lamp as claimed in claim 5, characterized in that the lamp base (3, 53) comprises a spring.

7. A reflector lamp as claimed in one or several of the preceding claims 1 to 4, characterized in that the glass bulb (5, 55) comprises a bulge (16).

8. A reflector lamp as claimed in one or several of the preceding claims 1 to 4 and 7, characterized in that the glass bulb (5, 55) and the cap (6, 56) are at a distance from one another.

9. A reflector lamp as claimed in claim 8, characterized in that a spring is arranged between the glass bulb (5, 55) and the cap (6, 56).

10. A reflector lamp as claimed in one or several of the preceding claims 1 to 4 and 7 to 9, characterized in that the glass bulb (5, 55) is at least partly surrounded by the cap (6, 56).

11. A reflector lamp as claimed in claim 1, characterized in that the halogen burner (4, 54) comprises two mutually opposed pinched ends (24, 25).

12. A reflector lamp as claimed in claim 11, characterized in that an electrical return lead (30) of the halogen burner (4, 54) comprises a locking means.

13. A reflector lamp as claimed in claim 1 and/or 11, characterized in that the halogen burner (4, 54) has an IR coating.
